(19) United States
(12) Patent Application Publication
(10) Pub. No.: US 2003/0030267 A1
(43) Pub. Date: Feb. 13, 2003

(54) Multi action note pad

(76) Inventor: Jenna E. Darvish, Los Angeles, CA (US)

Correspondence Address: Jenna E. DARVISH, 12310 First Helena drive, Los Angeles, CA, 90049, US

(21) Appl. No.: 10/151,344

(22) Filed: Aug. 12, 2002

Related U.S. Application Data
(60) Provisional application No. 60/292,787, filed on May 22, 2001.

(51) Int. Cl. B42D 1/00

(52) U.S. Cl. 281/28

(57) ABSTRACT

A self-adhesive note pad containing lines of perforations that allow each page of the note pad to be individually configurable to match the amount of information being written on the pad.

### BACKGROUND

1. Field of the Invention

The present invention relates generally to the field of adhesive note pads, and more specifically to adhesive note pad pages that can be tailored to fit the size of the note on the page in use.

2. Prior Art

Note pads of various sizes and configurations are well known in the prior art. Self-adhesive note pads are also well known and widely used. These note pads are manufactured and sold in various sizes. Thus, if you have a large note, you must use a relatively larger size pad. If you have a small note, you may use a smaller sized pad. This method of manufacture and use of different sizes of note pads requires the end-user to maintain a supply of variously sized note pads if he/she wishes to use the note pad page that is most efficiently sized for the note to be written. What is needed to address this problem is a note pad having pages that can be individually configured to the size of the note being written on the page.

It is therefore an object of the present invention to provide a note pad having pages that can be individually configured to the size of the note being written on the page.

Further features and advantages of the present invention will be appreciated by reviewing the following drawings and detailed description of the invention.

### BRIEF SUMMARY OF THE INVENTION

According to the present invention, an adhesive note pad has pages that can be individually configured to the size of the note being written on the page. Pages of the note pad of the invention are independently sized by the addition of lines of perforations on each page. The user having a small note will be able to write the note within the area of the page bounded by the appropriate number of perforations. By way of example, the smallest of notes may be written within the area bounded by the closest line of perforations to the edge of the paper. A slightly larger note may be written within the area bounded by the second line of perforations from the edge of the paper. Through the use of the perforated note pad of the invention, the user is able to use a note pad page that is appropriate for the size of the note being written, thereby reducing the need to maintain an inventory of multiply sized note pads.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a view of a self-adhesive note pad vertically sectioned in three parts by perforated lines;

FIG. 2 is a view of one portion of the three portions of the self-adhesive note pad page of FIG. 1 detached and used;

FIG. 3 is a view of two portions of the three portions of self-adhesive note pad page of FIG. 1 detached and used;

FIG. 4 is a view of a self-adhesive note pad with one horizontal perforated line situated beneath the end of the self-adhesive area;

FIG. 5 is a view of a page lifted from the pad of FIG. 4, including the self-adhesive and a strip;

FIG. 6 is a view of a page lifted from the pad of FIG. 4 with the adhesive area excluded;

FIG. 7 is a view of a combination of vertical and horizontal perforated lines in a self-adhesive note pad.

FIG. 8 is a view of the portions of the portions of the pad of FIG. 7, including the self-adhesive area;

FIG. 9 is a view of two portions of the self-adhesive note pad FIG. 7, excluding the self-adhesive area;

FIG. 10 is a view of a combination of vertical and horizontal line or lines on a self-adhesive note pad, creating non-equal areas; and

FIG. 11 is a view of an alternate embodiment according to the present invention including notches at the ends of lines of perforations with the notches used to facilitate detachment.

### DETAILED DESCRIPTION OF THE INVENTION

In the following description, for the purposes of explanation, specific component arrangements and constructions and other details are set forth in order to provide a more thorough understanding of the present invention. It will be apparent to those skilled in the art, however, that the present invention may be practiced without these specific details. In other instances, well known manufacturing methods and structures have not been described in detail so as not to obscure the present invention unnecessarily.

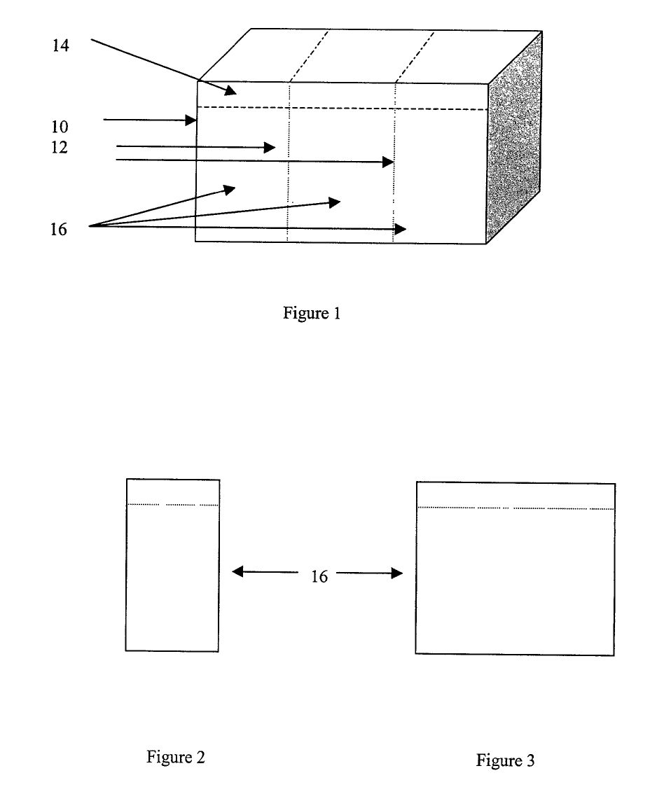

Referring first to FIG. 1, a note pad 10 is shown. In the preferred embodiment, the note pad 10 is rectangular in shape and has an adhesive strip 14 at its underside, at the top and back edge of each sheet. The note pad of the present invention includes lines of perforations 12 on each page. The lines of perforations 12 can be in any direction. In FIG. 1, the lines of perforations 12 are vertical, located from the top to the bottom of each page (including passing through the self-adhesive strip area) and divide each page into thirds. The number of lines of perforations 12 is irrelevant to the invention and as many lines of perforations 12 can be placed onto each page of the note pad 10 as a manufacturer deems to be useful. Each note pad 10 consists of many individual pages 16.

Referring next to FIGS. 2 and 3, it can be seen that a page 16 of the note pad 10 has been divided into two separate sheets. In FIG. 2, the sheet is ⅓ of the size of the original page size. In FIG. 3, the sheet is ⅔ of the size of the original page size. In this manner, an original page 16 of a note pad 10 can be configured to the size of the note being written on that portion of the original pad.

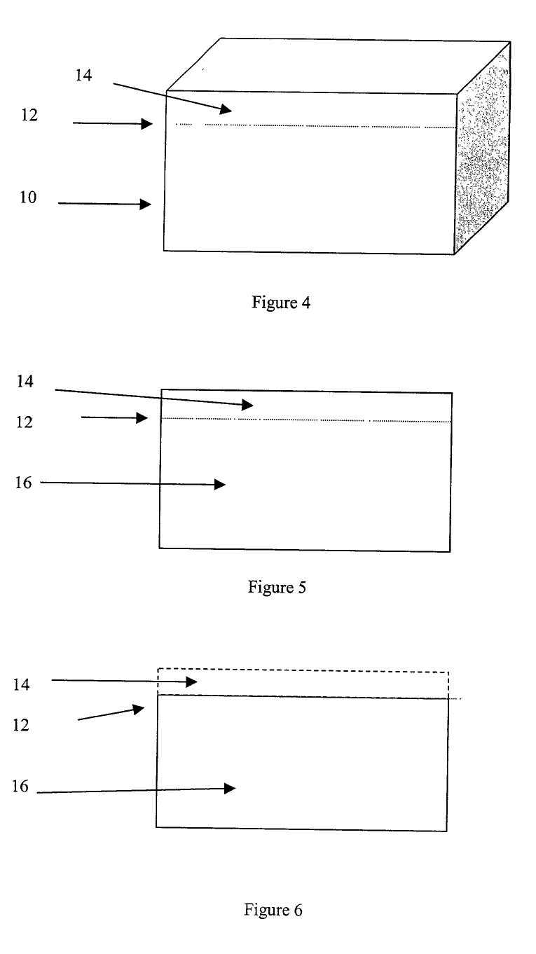

Referring next to FIG. 4, the lines of perforations 12 can be in any direction. As shown in this embodiment, the lines of perforations 12 are horizontal across the top of the page 16. As shown, a single page 16 can be used with the adhesive area 14 attached by removing the page 16 from the pad 10 without detaching the page 16 along the line of perforations 12. In the alternative, shown in FIG. 6, a single page 16 can be used with the adhesive area 14 separated from the page by removing the page 16 along the line of perforations 12.

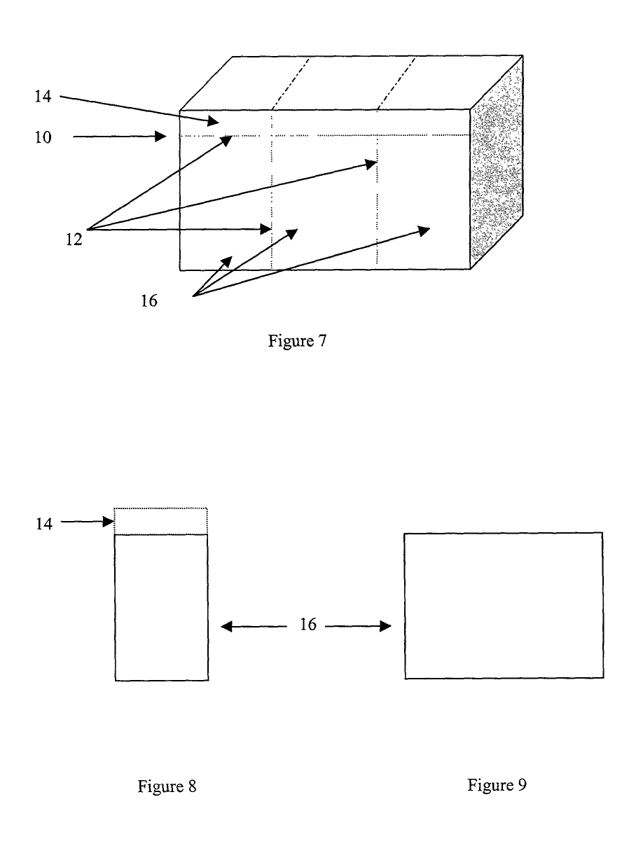

Referring next to FIG. 7, the note pad 10 is shown with both vertical and horizontal lines of perforations 12. Additionally, the pad 10 has an adhesive strip 14. Individual areas of note pad page 16 are defined by the placement of the lines of perforations 12. As seen in FIG. 8, an individual page 16 can be formed using the vertical lines of perforations and a single horizontal line of perforations 12.

The page 16 may be used with or without the adhesive strip 14. As seen in FIG. 9, an individual page 16 is created by using the horizontal line of perforations 12 separated from the adhesive strip area.

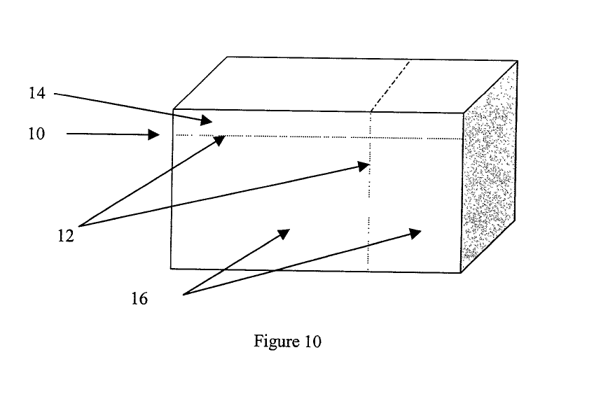

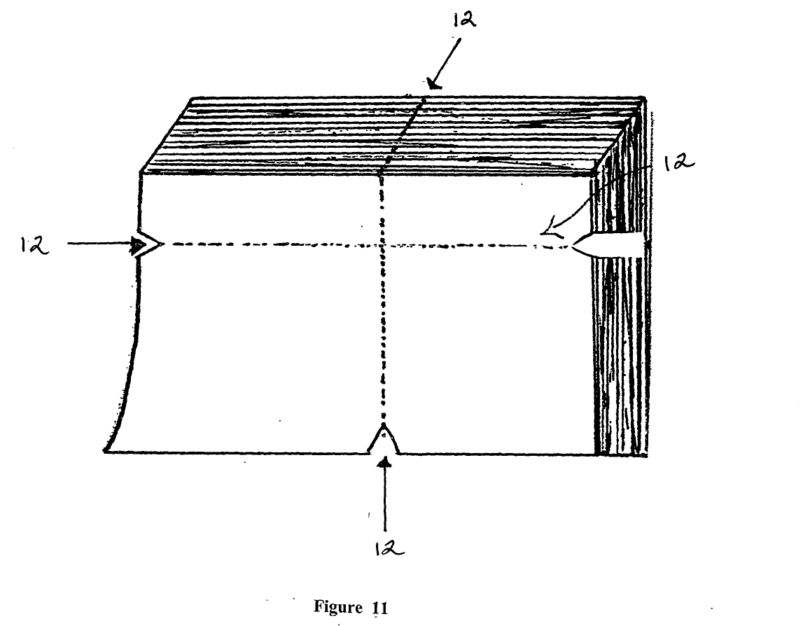

Referring next to FIG. 10, the lines of perforations 12 may be arbitrarily spaced and result in page portions of unequal size.

Finally, as shown in FIG. 11, the individual lines of perforations 12 may include cutouts at the beginning of each line or perforation 12, to assist in detaching the portion from the page.

The description of the present invention has been made with respect to specific arrangements and constructions of a note pad having a configurable page size. It will be apparent to those skilled in the art that the foregoing description is for illustrative purposes only, and that various changes and modifications can be made to the present invention without departing from the overall spirit and scope of the present invention. The full extent of the present invention is defined and limited only by the following claims.

What is claimed is:

1. A note pad comprising:
a plurality of pages bound together;
each page of said plurality of pages having a self-adhesive strip at the top of the underside of said page; and
each said page of said plurality of pages having a plurality of lines of perforations.

2. The invention of claim 1 wherein said plurality of lines of perforations are vertically arranged.

3. The invention of claim 1 wherein said plurality of lines of perforations are horizontally arranged.

4. The invention of claim 1 wherein said plurality of lines of perforations is both vertically and horizontally arranged.

5. The invention of claim 1 wherein said plurality of lines of perforations are not aligned with the boundaries of any said page of said plurality of said pages.

6. The invention of claim 1 wherein said lines of perforations terminate at the edge of each page with a cut out portion.

7. The invention of claim 1 wherein each of said lines of perforations terminate in a notch at the edge of each page to facilitate separation at each line of perforation.

8. The invention of claim 1 wherein said plurality of lines of perforations are mutually aligned.

9. The invention of claim 1 wherein said plurality of lines of perforations are not mutually aligned.
